(19) United States
(12) Patent Application Publication
(10) Pub. No.: US 2012/0096945 A1
(43) Pub. Date: Apr. 26, 2012

(54) PRESSURE SENSOR

(75) Inventor: Kenta SATO, Kamiina (JP)

(73) Assignee: SEIKO EPSON CORPORATION, Tokyo (JP)

(21) Appl. No.: 13/190,702

(22) Filed: Jul. 26, 2011

(30) Foreign Application Priority Data
Oct. 25, 2010 (JP) 2010-238948

(51) Int. Cl. G01L 9/08

(52) U.S. Cl. 73/723; 73/756

(57) ABSTRACT

A pressure sensor includes a container, a pressure receiving unit that seals an opening section of the container, has a pressure receiving section and a peripheral section outside the pressure receiving section, a plurality of support members having one ends affixed to the peripheral section and other ends that extend from the one ends in parallel with a direction of displacement of the pressure receiving unit, a pressure-sensitive element; and a fixing plate having a first connection segment that affixes the second base portion of the pressure-sensitive element, and a second connection segment that extends both ends of the first connection segment toward at least one of main surface sides of the first connection segment and connects to the other ends of the support members.

### BACKGROUND

1. Technical Field

The present invention relates to a pressure sensor that is equipped with a diaphragm and a pressure-sensitive element, which detects pressures from changes in the frequency of the pressure-sensitive element based on displacement of the diaphragm.

2. Related Art

Pressure sensors that use a piezoelectric oscillator element as a pressure-sensitive element are known and used as water pressure meters, atmospheric pressure meters, differential pressure meters and the like. A pressure sensor having the configuration described above is typically equipped with a pressure-sensitive element having a plate-like quartz crystal substrate and an electrode pattern that is formed on the substrate and is capable of exciting vibrations. The detection axis of the pressure-sensitive element is aligned with the direction in which force is detected. With such a configuration, when a force (pressure) is applied in the direction in which the detection axis is disposed, the resonance frequency of vibration that is excited by the pressure-sensitive element changes. Therefore, by converting the change in the resonance frequency to a force, the applied pressure can be detected.

JP-A-2007-57395 and JP-A-2002-214058 describe pressure sensors essentially having the configuration described above. FIG. 13 shows a pressure sensor 100 described in JP-A-2007-57395. The pressure sensor 100 is configured essentially with an airtight case 102, first and second bellows 104 and 106, a piezoelectric vibration element 108 and an oscillation circuit 110. The airtight case 102 has a cylindrical external shell, and a vacuum is drawn or an inert atmosphere is provided therein. The first and second bellows 104 and 106 are disposed within the airtight case 102 in a manner to cover through-holes (pressure input ports 112 and 114) formed respectively in a pair of end plates composing the external shell of the airtight case 102. A vibration element bonding pedestal 116 is provided between the first and second bellows 104 and 106. The vibration element bonding pedestal 116, which is disposed between the first and second bellows 104 and 106 that extend or contract according to the pressure applied through the pressure input ports 112 and 114, moves between the end plates according to extension and contraction of the first and second bellows 104 and 106. The piezoelectric vibration element 108 is disposed between one of the end plates composing the airtight case 102 and the vibration element bonding pedestal 116, and is configured such that its resonance frequency changes according to stress caused by movements of the vibration element bonding pedestal 116. The oscillation circuit 110 is electrically connected to the excitation electrode composing the piezoelectric vibration element 108, excites vibration on the piezoelectric vibration element 108 and detects the excited vibration. A differential pressure between pressures applied to the first and second bellows 104 and 106 can be detected based on a change in the resonance frequency of the detected vibration.

A pressure sensor 200 described in JP-A-2002-214058, as shown in FIG. 14, is configured essentially with a substrate 202 and a silicon structure body 204. The substrate 202 includes, on its main surface, an electrode 206 composed of a metal thin film and a dielectric film 208 covering the electrode 206. The silicon structure body 204 has a conductive diaphragm 210 that is deformable according to pressures, and is bonded to the main surface of the substrate 202 in a manner that a gap 212 is created between the diaphragm 210 and the electrode 206 when they are disposed facing each other. In the pressure sensor 200 with the configuration described above, when the diaphragm 210 is deformed upon receiving a pressure, the contact area between the diaphragm 210 and the dielectric film 208 on the substrate 202 changes, and a change in the electrostatic capacitance of the dielectric film 208 caused by the change in the contact area is detected, whereby the pressure applied to the diaphragm 210 can be detected.

The pressure sensors described in JP-A-2007-57395 and JP-A-2002-214058 are capable of detecting differential pressures and absolute pressures, respectively. However, each of the pressure sensors entails structural problems as follows. The pressure sensor described in JP-A-2007-57395 has a problem in that detected pressures have substantial errors caused by the difference in coefficient of linear expansion between the airtight case and the piezoelectric vibration element. Also, the pressure sensor described in JP-A-2002-214058 has a problem in that detected pressures have errors caused by warping of the diaphragm due to its own weight.

To address the problems described above, the applicant of the present application has proposed a pressure sensor which suppresses errors that may be caused by the influence of difference in the coefficient of linear expansion or its own weight, and is capable of highly accurate pressure detection, as described in JP-A-2010-48798. As shown in FIG. 15, a pressure sensor 300 described in JP-A-2010-48798 is configured essentially with a piezoelectric oscillator element 302, a housing 304 that contains the piezoelectric oscillator element 302, and a diaphragm 306 provided at one end of the housing 304. The housing 304 is sealed on the other end opposite to the diaphragm 306, and a vacuum is drawn or an inactive atmosphere is provided in the housing 304. The diaphragm 306 is equipped with a central area 308, a flexible area 310 and an outer peripheral area 312, and configured such that the central area 308 located interior of the flexible area 310 functions as a pressure-sensitive section. The piezoelectric oscillator element 302 has a first base portion 316a that is connected to the central area 308 of the diaphragm 306, and a second base portion 316b extending to a connection section 318 that is connected to hermetic terminals 320 provided on the outer peripheral area 312 of the diaphragm 306 so as to provide electrical connection to the outside. According to the pressure sensor 300 with the configuration described above, the two ends of the piezoelectric vibration element 302 are connected to the diaphragm 306, such that errors in detected pressures which may be caused by a difference between the coefficients of linear expansion can be suppressed.

The pressure sensor with the configuration described in JP-A-2010-48798 can reliably suppress errors in detected pressures which may be caused by difference in coefficient of linear expansion or errors in detected pressures which may be caused by warping of the diaphragm by its own weight. However, the pressure sensor described in JP-A-2010-48798 is configured such that the piezoelectric oscillator element and the connection section are formed in a common plane, and the piezoelectric oscillator element is affixed in a cantilever style with respect to the diaphragm. Therefore, there is a tendency that the tolerance against impacts in the direction perpendicular to the common plane including the piezoelectric vibration element and the connection section becomes lower.

### SUMMARY

In accordance with an advantage of some aspects of the invention, it is possible to provide a pressure sensor that enables highly accurate pressure detection and has greater tolerance against vibrations and impacts in the direction perpendicular to an element plane (in a plane direction) of the piezoelectric vibration element.

### Application Example 1

A pressure sensor includes a container, a pressure receiving unit that seals an opening section of the container, has a pressure receiving section and a peripheral section outside the pressure receiving section, and displaces inwardly or outwardly of the container upon receiving a force, a plurality of support members having one ends affixed to the peripheral section and other ends that extend from the one ends in parallel with a direction of displacement of the pressure receiving unit, a pressure-sensitive element having a first base portion affixed to the pressure receiving section and a second base portion disposed extending from the first base portion in parallel with the direction of displacement of the pressure receiving unit, and a fixing plate having a first connection segment that affixes the second base portion of the pressure-sensitive element, and a second connection segment that extends both ends of the first connection segment toward at least one of main surface sides of the first connection segment thereby connecting to the other ends of the support members.

According to the configuration described above, a bonding surface of the second base portion of the pressure-sensitive element and a bonding surface of the other ends of the support members are not located on a common plane, and the second base portion of the pressure-sensitive element is supported by the fixing plate and the supporting members from one of the main surface sides. Therefore, the fixing plate and the supporting members can act as stoppers to counter external force such as vibrations and impacts in a direction perpendicular to the element plane of the pressure-sensitive element. Accordingly, the impact tolerance against external force to the element plane of the pressure-sensitive element can be improved.

### Application Example 2

In the pressure sensor recited in Application Example 1, the second connection segment may extend one of the ends of the first connection segment toward the one of main surface sides of the first connection segment and extend the other of the ends of the first connection segment toward the other of the main surface sides of the first connection segment thereby connecting to the other ends of the support members.

According to the configuration described above, a bonding surface of the second base portion of the pressure-sensitive element and a bonding surface of the other ends of the support members are not on a common plane, and the second base portion of the pressure-sensitive element is supported by the fixing plate and the supporting members from one and the other of the main surface sides. Therefore, the fixing plate and the supporting members can act as stoppers to counter external force such as vibrations and impacts exerted in a direction perpendicular to the element plane of the pressure-sensitive element. Accordingly, the impact tolerance against external force to the element plane of the pressure-sensitive element can be improved.

### Application Example 3

In the pressure sensor recited in Application Example 1, the second connection segment may extend both ends of the first connection segment toward both of the main surface sides of the first connection segment thereby connecting to the other ends of the support members.

According to the configuration described above, a bonding surface of the second base portion of the pressure-sensitive element and a bonding surface of the other ends of the support members do not fall on a common plane, and both ends of the second base portion of the pressure-sensitive element are supported by the fixing plate and the supporting members from both of the main surface sides. Therefore, the fixing plate and the supporting members can act as stoppers to counter external force such as vibrations and impacts exerted in a direction perpendicular to the element plane of the pressure-sensitive element. Accordingly, the impact tolerance against external force to the element plane of the pressure-sensitive element can be improved.

### Application Example 4

In the pressure sensor recited in Application Example 1, the container may have a second opening section formed opposite to the opening section, the second opening section may be sealed by a second pressure receiving unit, and the pressure receiving unit and the second pressure receiving unit may be connected to each other through a force transmission shaft.

With the configuration described above, when the pressure is higher on the side of the pressure receiving unit, the pressure-sensitive element is subject to compression stress. On the other hand, when the pressure is higher on the side of the second pressure receiving unit, the pressure-sensitive element is subject to extension stress. Therefore, a pressure sensor capable of measuring relative pressure can be obtained.

### Application Example 5

In the pressure sensor recited in Application Example 1, the pressure-sensitive element may be an AT-cut quartz crystal unit. By such a configuration, a pressure sensor with higher frequency and shorter measuring time, compared to a tuning-folk type piezoelectric oscillator, can be obtained.

### BRIEF DESCRIPTION OF THE DRAWINGS

FIG. 1 is a perspective view of a pressure sensor in accordance with a first embodiment with a portion thereof being exposed.

FIGS. 2A and 2B are cross-sectional views of the pressure sensor in accordance with the first embodiment, where FIG. 2A is a cross-sectional view taken along XZ plane, and FIG. 2B is a cross-sectional view taken along XY plane.

FIGS. 3A and 3B are diagrammatic views of pressure sensors in accordance with modified examples 1 and 2 of the first embodiment, where FIG. 3A is a cross-sectional view of the modified example 1 taken along XY plane, and FIG. 3B is a cross sectional view of the modified example 2 taken along XY plane.

FIG. 4 is a perspective view of a pressure sensor in accordance with a second embodiment with a portion thereof being exposed.

FIGS. 5A and 5B are cross-sectional views of the pressure sensor in accordance with the second embodiment, where FIG. 5A is a cross-sectional view taken along XZ plane, and FIG. 5B is a cross-sectional view taken along XY plane.

FIG. 6 is a diagrammatic view of a pressure sensor in accordance with a modified example 3 of the second embodiment.

FIG. 7 is a perspective view of a pressure sensor in accordance with a third embodiment with a portion thereof being exposed.

FIGS. 8A and 8B are cross-sectional views of the pressure sensor in accordance with the third embodiment, where FIG. 8A is a cross-sectional view taken along XZ plane, and FIG. 8B is a cross-sectional view taken along XY plane.

FIGS. 9A and 9B are diagrammatic views of pressure sensors in accordance with modified examples 4 and 5 of the third embodiment, where FIG. 9A is a cross-sectional view of the modified example 4 taken along XY plane, and FIG. 9B is a cross-sectional view of the modified example 5 taken along XY plane.

FIG. 10 is a perspective view of a pressure sensor in accordance with a fourth embodiment with a portion thereof being exposed.

FIGS. 11A and 11B are cross-sectional views of the pressure sensor in accordance with the fourth embodiment, where FIG. 11A is a cross-sectional view taken along XZ plane, and FIG. 11B is a cross-sectional view taken along XY plane.

FIG. 12 is a perspective view of a pressure sensor in accordance with a fifth embodiment with a portion thereof being exposed.

FIG. 13 is a schematic diagram of a pressure sensor described in JP-A-2007-57395.

FIG. 14 is a schematic diagram of a pressure sensor described in JP-A-2002-214058.

FIG. 15 is a schematic diagram of a pressure sensor described in JP-A-2010-48798.

### DESCRIPTION OF EXEMPLARY EMBODIMENTS

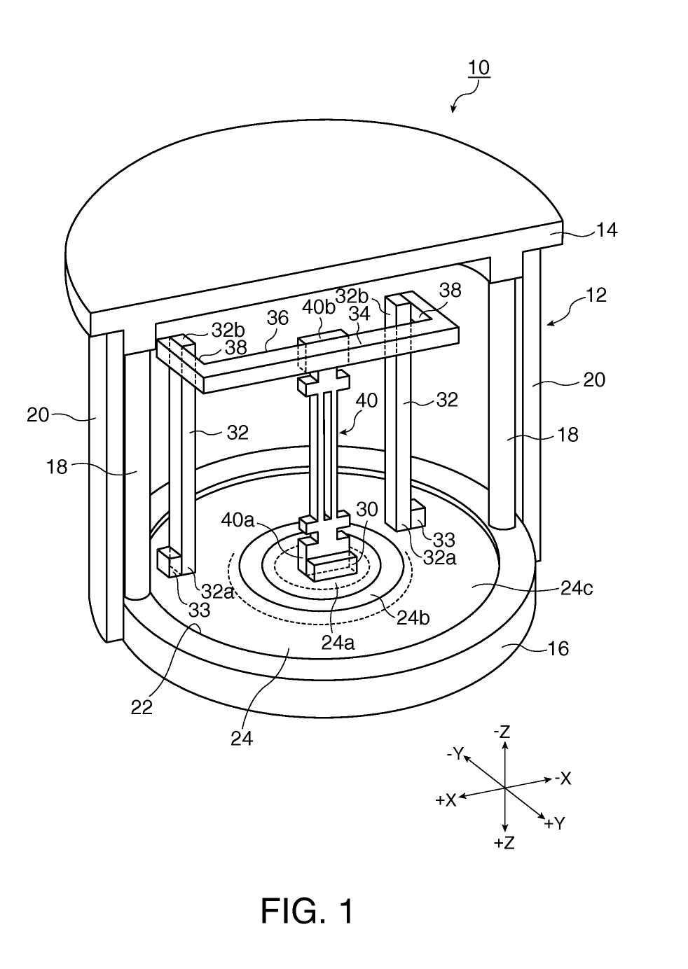

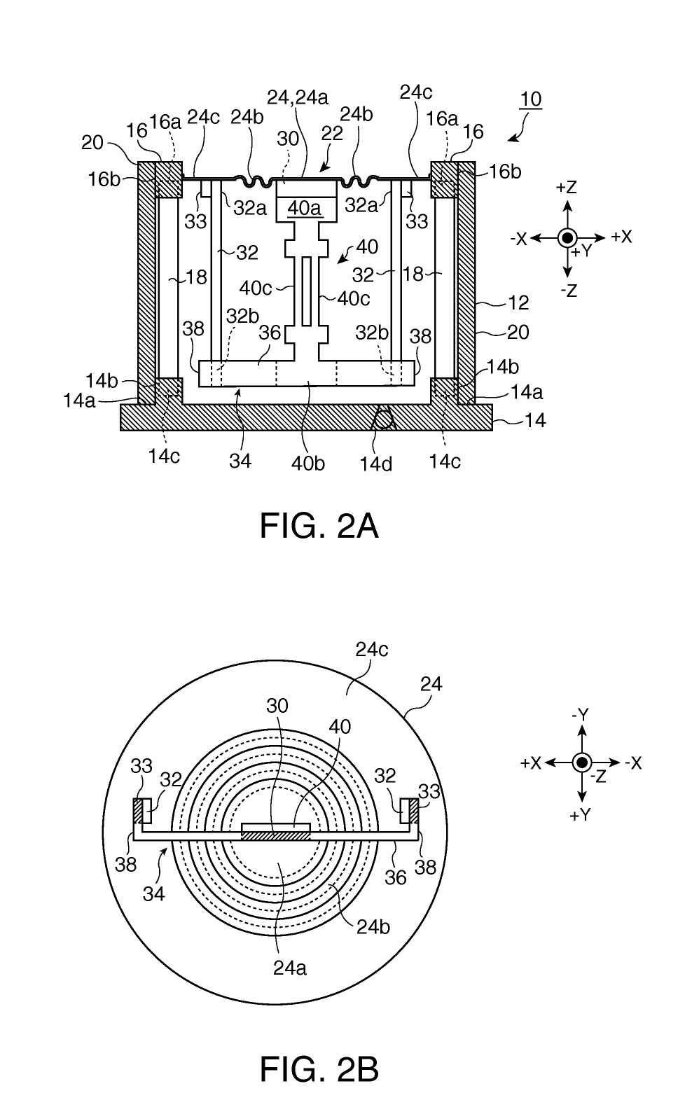

Pressure sensors in accordance with embodiments of the invention will be described in detail below with reference to the accompanying drawings. FIG. 1 is a perspective view of a pressure sensor in accordance with a first embodiment with a portion thereof being exposed. FIGS. 2A and 2B are cross-sectional views of the pressure sensor in accordance with the first embodiment, where FIG. 2A is a cross-sectional view taken along XZ plane, and FIG. 2B is a cross-sectional view taken along XY plane (its housing excluded). It is noted that reference signs XYZ in FIGS. 1 and 2 constitute an orthogonal coordinate system, which will be similarly applied to other drawings to be used below.

A pressure sensor 10 in accordance with the first embodiment includes a housing 12 and a diaphragm 24 as a container, and a pressure-sensitive element 40, support members 32 and a fixing plate 34 within a storage space of the container equipped with the diaphragm 24. For example, when the interior of the housing 12 is opened to the atmosphere, the pressure sensor 10 may be used as a liquid pressure sensor that receives liquid pressure from the outside of the diaphragm 24 with the atmospheric pressure as the reference. Also, when a vacuum is drawn in the housing 12, the pressure sensor 10 can be used as an absolute pressure sensor with a vacuum as the reference.

The housing 12 includes a circular flange portion 14, a circular ring portion 16, support shafts 18, and a cylindrical side surface portion (sidewall portion) 20. The flange portion 14 includes an outer peripheral portion 14a that is in contact with an end section of the cylindrical side surface portion (sidewall portion) 20, and an inner peripheral portion 14b that protrudes in a ring shape having the same diameter of that of the ring portion 16. The ring portion 16 includes a circular opening 22 that is formed by an inner peripheral edge of the ring portion 16. A diaphragm 24 is connected to the opening 22 in a manner to seal the opening 22. The diaphragm 24 forms a part of the housing 12. Bores 14c and 16a for fitting the support shafts 18 are formed at predetermined positions in mutually opposing faces of the inner peripheral portion 14b of the flange portion 14 and the ring portion 16, respectively. Further, the bores 14c and the bores 16a are formed at mutually opposing positions, respectively. Therefore, by fitting the support shafts 18 in the bores 14c and 16a, the flange portion 14 and the ring portion 16 are connected through the support shafts 18. The support shafts 18 are each a rod-like member having a constant rigidity and a longitudinal direction in the ±Z direction, and are arranged in the interior of the container comprised of the housing 12 and the diaphragm 24. One ends of the support shafts 18 are fitted in the bores 14c of the flange portion 14, and the other ends thereof are fitted in the bores 16a of the ring portion 16, whereby a constant rigidity is ensured among the flange portion 14, the support shafts 18 and the ring portion 16. The support shafts 18 are used in plurality, and arranged according to specified design of positions of the respective bores.

Hermetic terminals (not shown) are attached to the flange portion 14. The hermetic terminals, together with an electrode portion (not shown) of a pressure-sensitive element 40 to be described, are provided to oscillate the pressure-sensitive element 40, and may be electrically connected to an integrated circuit (IC) (not shown) attached to the external surface of the housing 12, or disposed outside of the housing 12 and separated from the housing 12. When the pressure sensor is used as the aforementioned liquid pressure sensor, an atmosphere introducing port 14d may be formed in the flange portion 14, whereby the interior of the housing 12 is opened to the atmosphere. By connecting both end sections of the side surface portion 20 respectively to the outer circumference of the inner peripheral portion 14b of the flange portion 14, and to the outer circumference 16b of the ring portion 16 with its opening 22 sealed by the diaphragm 24, the container is sealed. The flange portion 14, the ring portion 16, and the side surface portion 20 may preferably be formed from metal such as stainless steel, and the support shafts 18 may preferably be formed from ceramics having a constant rigidity and a small thermal expansion coefficient.

The diaphragm 24 has a pressure-receiving surface on one of its main surfaces facing the outside of the housing 12. The pressure-receiving surface has a flexible portion that is capable of flexural deformation upon receiving a pressure in a measured pressure environment (for example, liquid). As the flexible portion is subjected to flexural deformation in a manner to displace toward the inner side or the exterior side (in the Z axis direction) of the housing 12, a compression force or a tensile force generated is transmitted along the Z axis to the pressure-sensitive element 40 inside the housing 12. The diaphragm 24 includes a center area 24a which can be displaced by a pressure from the outside, a flexible area 24b located on the outer periphery of the center area 24a and subjected to the flexural deformation by the pressure from the outside, and a peripheral edge area 24c located on the outer periphery of the flexible area 24b and joined and fixed to the inner wall of the opening 22 formed in the ring portion 16. Ideally, the peripheral edge area 24c would not be displaced upon receiving a pressure, and the center area 24a would not be displaced upon receiving a pressure. The center area 24a inside the diaphragm 24 on the opposite side surface of the pressure receiving surface is connected to one end (a first base portion 40a), in the longitudinal direction (the detection axis direction), of the pressure-sensitive element 40 to be describe below. The material of the diaphragm 24 may preferably be those superior in anti-corrosion property such as metal like stainless steel or ceramics. For example, when metal is used, the diaphragm 24 may be formed by subjecting metal base material to press-processing. The diaphragm 24 may be coated on its surface exposed to the outside with an anti-corrosive film so as not to be corroded by liquid, gas or the like. For example, the diaphragm 24 made of metal may be coated with a nickel compound. A first support base 30 is connected to the center area 24a of the diaphragm 24, and support members 32 (to be described below) are connected to the peripheral edge area 24c of the diaphragm 24. The first support base 30 connected to the center area 24a is connected to a first base portion 40a of the pressure-sensitive element 40. The first support base 30 in accordance with the first embodiment may be made of material having the same property as that of the diaphragm 24 that functions as a pressure receiving unit, in other words, material having excellent anti-corrosive property such as metal like stainless steel or ceramics.

The pressure-sensitive element 40 includes a vibration arm 40c serving as a pressure sensing section, and a first base portion 40a and a second base portion 40b formed at both ends of the vibration arm 40c, respectively, and is formed from piezoelectric material, such as, quartz crystal, lithium niobate, or lithium tantalite. The first base portion 40a is connected to a side surface of the support base 30, and is abutted against the center area 24a. The second base portion 40b is connected to a first connecting segment 36 of a fixing plate 34 to be described below. The pressure-sensitive element 40 has an excitation electrode (not shown) formed on the vibration arm 40c, and an electrode portion (not shown) that is electrically connected to the excitation electrode (not shown). Therefore, the pressure-sensitive element 40 is disposed such that the longitudinal direction thereof (the Z axis direction), that is, a direction in which the first base portion 40a and the second base portion 40b are arranged is set to be coaxial or parallel with a displacement direction (the Z axis direction) of the diaphragm 24, and the displacement direction is set as the detection axis. As the pressure-sensitive element 40 is affixed by the first support base 30 and the fixing plate 34, the pressure-sensitive element 40 does not bend in directions other than the detection axis direction upon receiving the force by displacements of the diaphragm 24, such that the pressure-sensitive element 40 can be prevented from moving in directions other than the detection axis direction, whereby reduction in the sensitivity of the pressure-sensitive element 40 in the detection axis direction can be suppressed.

The pressure-sensitive element 40 is electrically connected with the IC (not shown) through the hermetic terminal (not shown) and wires (not shown), and vibrates at a natural resonance frequency in response to alternating voltage supplied from the IC (not shown). The resonance frequency of the pressure-sensitive element 40 changes as it receives extensional stress or compressive stress in the longitudinal direction thereof (the Z axis direction). In accordance with the present embodiment, a double-ended tuning fork type oscillator may be used as the vibration arm 40c that serves as the pressure-sensitive portion. The double-ended tuning fork type oscillator includes two vibration beams and has such a property that when tensile stress (extensional stress) or compressive stress is applied to the two vibration beams serving as the vibration arm 40c, its resonance frequency changes generally in proportion to the applied stress. The resonance frequency of a double-ended tuning fork type piezoelectric resonator element changes substantially greater with respect to the extensional and compressive stress and therefore variable width of the resonance frequency is greater, compared to other types of resonators such as a thickness shear resonator. Therefore, a double-ended tuning fork type resonator element is suitable for a pressure sensor requiring excellent resolving power capable of detecting a slight pressure difference. When the double-ended tuning fork type piezoelectric resonator receives extensional stress, the resonance frequency of the vibration arm increases. When the resonator receives compressive stress, the resonance frequency of the vibration arm decreases. In the present embodiment, it is possible to use not only the pressure sensing part having two vibration beams but also a pressure sensing part having a single vibration beam (single beam). When the pressure sensing part (vibration arm 40c) is composed of a single beam and receives certain stress in the longitudinal direction (the detection axis direction), the displacement thereof is doubled, thereby providing the pressure sensor with higher sensitivity than that of the tuning fork type. A piezoelectric substrate of the double-ended tuning fork type or single beam type piezoelectric resonator is preferably made of quartz crystal which has excellent temperature characteristics.

The support member 32 may be a supporting rod provided with the same length as that of the pressure-sensitive element 40 for supporting the second base portion 40b of the pressure-sensitive element 40. The support member 32 is made of material having the same property as that of the pressure-sensitive element 40, in other words, piezoelectric material, such as, quartz crystal, lithium niobate, lithium tantalite or the like. A plurality of the support members 32 (two support members in the present embodiment) are used in order to support the second base portion 40b of the pressure-sensitive element 40 at both ends thereof symmetrically with respect to the second base portion 40b as a center (line-symmetrically with respect to the YZ plane as a center). The support members 32 have one ends 32a affixed to the peripheral edge area 24c of the diaphragm 24 in a manner to traverse the peripheral edge area 24c, and the other ends 32b extending from the one ends 32a in parallel with the displacement direction (the Z axis direction) of the pressure-sensitive element 40 and affixed to a second connection segment 38 of the fixing plate 43 (to be described below). The one ends 32a of the support members 32 are bonded and affixed to second support bases 33 that stand from the peripheral edge area 24c of the diaphragm 24. The second support base 33, like the first support base 30, is formed from material having the same property as that of the diaphragm 24 that serves as the pressure receiving unit, in other words, material having excellent anti-corrosive property such as metal like stainless steel or ceramics. The support members 32 each has a rectangular cross section so as to secure a large bonding area when it is bonded with the second support base 33 and the fixing plate 34 to be described below.

The fixing plate 34 is configured with a first connection segment 36 and a second connection segment 38. The fixing plate 34 is a member bonded to the second base portion 40b of the pressure-sensitive element 40 and to the other ends 32b of the support members 32, to affix the pressure-sensitive element 40 and the support members 32 with their longitudinal direction being in parallel with the displacement direction (the Z axis direction) of the diaphragm 24. The fixing plate 34 is made of material having the same property as that of the diaphragm 24, in other words, material having excellent anti-corrosive property such as metal like stainless steel or ceramics. The fixing plate 34 has the first connection segment 36 that is bonded with the second base portion 40b of the pressure-sensitive element 40, and both ends of the first connection segment 36 are bent and extended toward one of the main surfaces. In the fixing plate 34 in accordance with the present embodiment, both end sections of the first connection segment 36 are bent at right angle to define the second connection segments 38, thereby forming the overall configuration in a squared channel shape as viewed in a plan view. It is noted that the second connection segments 38 are formed to be positioned in areas that are superposed with the peripheral edge area 24c of the diaphragm 24 as viewed in a plan view, when the first connection segment 36 is connected to the second base portion 40b of the pressure-sensitive element 40. The fixing plate 36 may be formed by bending a flat plate into a squared channel shape to provide the first and second connection segments 36 and 38, or may be formed by welding a pair of connection segments defining the second connection segments 38 to both ends of a connection segment defining the first connection segment 36. The fixing plate 36 is formed from rigid members such as stainless steel connected together, therefore has predetermined strength, such that the fixing plate 34 would not deform due to deformation of the diaphragm 24 generated upon application of a pressure thereto.

In the present embodiment, the pressure-sensitive element 40 has the two ends (the first and second base portions 40a and 40b) in the longitudinal direction that are consequently connected to the diaphragm 24 through the fixing plate 34 and the support members 32. By this structure, thermal strain given from the housing 12 to the pressure-sensitive element 40 can be reduced. More specifically, as the pressure-sensitive element 40 and the support members 32 are made of material having the same property (e.g., the same material), such that their rates of expansion or contraction in the detection axis direction caused by temperature changes may become identical. Therefore, in expansion or contraction in the detection axis direction caused by temperature changes, thermal strain of the support members 32 that may affect the pressure-sensitive element can be reduced. Further, as the fixing plate 34 uses material of the same property as that of the pressure receiving unit, no thermal strain would be generated between the pressure receiving unit and the pressure-sensitive element 40 in components in the direction perpendicular to the detection axis direction, and therefore the pressure-sensitive element 40 would not be affected by any thermal strain.

The pressure sensor 10 in accordance with the first embodiment may be manufactured as follows. First, the diaphragm 24 is connected to the ring portion 16, the first support base 30 is connected to the center area 24a of the diaphragm 24, and the second support base 33 is connected to the peripheral edge area 24c of the diaphragm 24. The aforementioned components may be connected to one another by any connection method, such as, fixing agent such as adhesive, laser welding, arc welding, soldering or the like.

Then, the first base portion 40a of the pressure-sensitive element 40 is connected to the side surface of the first support base 30, and the second base portion 40b is connected to the first connection segment 36 of the fixing plate 34. The aforementioned components may be connected to one another by adhesive or the like.

The one ends 32a of the support members 32 are connected to the side surfaces of the second support base 33, and the other ends 32b are connected to the second connection segments 38 of the fixing plate 34. The aforementioned components may be connected with one another by any connection method, such as, fixing agent such as adhesive, laser welding, arc welding, soldering or the like.

Then, one ends of the support shafts 18 are inserted and fixed in the bores 16a of the ring portion 16, the other ends of the support shafts 18 with the one ends having already been inserted in the ring portion 16 are inserted and fixed in the bores 14c of the flange portion 14, and the hermetic terminal (not shown) on the interior side of the housing 12 and the electrode portion (not shown) of the pressure-sensitive element 40 are electrically connected by wires (not shown). At the same time, the hermetic terminal (not shown) on the exterior side of the housing 12 is connected to an IC (not shown). Lastly, the side surface portion 20 is inserted from the side of the ring section 16 and brought in contact with the outer circumference of the flange portion 14 and the outer circumference 16b of the ring portion 16, thereby forming the housing 12, whereby the pressure sensor 10 is manufactured. When the pressure sensor 10 is used as a pressure sensor to measure absolute pressure with a vacuum as the reference, the atmosphere introducing port 14d may not be formed, and the pressure sensor 10 may be assembled in a vacuum.

The pressure sensor 10 described above is configured such that the bonding surface of the second base portion 40b of the pressure-sensitive element 40 and the bonding surfaces of the other ends of the pair of the support members 32 are not on the same plane, and the bonding surfaces of the other ends of the support members 32 that are arranged at positions symmetrical through the bonding surface of the second base portion 40b as the center and the bonding surface of the second base portion 40b are both supported through the fixing plate 34.

Next, the operation of the pressure sensor 10 in accordance with the first embodiment is described below. When liquid pressure is measured with the atmospheric pressure as the reference, and when the liquid pressure is lower than the atmospheric pressure, the center area 24a of the diaphragm 24 displaces toward the inside of the housing 12, and when the liquid pressure is higher than the atmospheric pressure, the center area 24a of the diaphragm 24 displaces toward the outside of the housing 12. When the center area 24a of the diaphragm 24 displaces toward the outside of the housing 12, the pressure-sensitive element 40 is subjected to tensile stress due to the center area 24a and the support members 32. On the other hand, when the center area 24a of the diaphragm 24 displaces toward the inside of the housing 12, the pressure-sensitive element 40 is subjected to compressive stress due to the center area 24a and the support members 32.

When there is a change in the temperature in the pressure sensor 10, the housing 12, the diaphragm 24, the support members 32, the fixing plate 34, and the pressure-sensitive element 40 which form the pressure sensor 10 expand and contract according to their respective thermal expansion coefficients, respectively. However, both ends of the pressure-sensitive element 70 in the detection axis direction are connected to the side of the diaphragm 24, thermal strain resulting from expansion and contraction in the Z axis direction of the housing 12 are reduced.

Also, due to a difference in the thermal expansion coefficient between the pressure-sensitive element 40 and the diaphragm 24, the pressure-sensitive element 40 would receive thermal strain from the diaphragm 24 through the support members 32 due to expansion and contraction in the direction perpendicular to the detection axis (in the X axis direction) caused by temperature changes. However, the fixing plate 34 arranged in the X axis direction uses the same material as that of the diaphragm 24. Therefore, the amount of thermal strain to be exerted to the pressure-sensitive element 40 can be reduced, such that the pressure sensor 10 can reduce errors in measured values of pressure that may be caused by temperature changes.

The pressure sensor 10 may be configured such that both ends of a first bonding surface of the fixing plate are made to extend toward one of the main surface sides with respect to the first bonding surface, thereby forming second bonding surfaces, such that the first and second bonding surfaces of the fixing plate are not on the same plane, in other words, the bonding surface of the second base portion 40b of the pressure-sensitive element 40 and the bonding surfaces of the other ends of the support members are not on the same plane. By this configuration, the second base portion 40b of the pressure-sensitive element 40 is supported by the fixing plate and the supporting members 32 from one of the main surface sides. Therefore, the fixing plate 34 and the supporting members 32 can act as stoppers to counter external force such as vibrations and impacts in a direction perpendicular to the element plane of the pressure-sensitive element 40. Accordingly, the impact tolerance against external force to the element plane of the pressure-sensitive element 40 can be improved.

Acceleration stresses in the direction perpendicular to a pressure-sensitive element plane were compared between a pressure sensor with a plane configuration in which a fixing plate that is not in a bent shape and a pressure-sensitive element are formed on the same plane and the pressure sensor in accordance with the first embodiment. The pressure sensor with the plane configuration marked 210 MPa/1000 g, and the pressure sensor in accordance with the first embodiment marked 80 MPa/1000 g. Therefore, the pressure sensor configured with the bent fixing plate in accordance with the first embodiment has less than half the stress of the pressure sensor with the plane configuration, and thus proves to have strong shock-tolerance against acceleration stress in the vertical direction of the pressure sensor. The minimum resonance frequency of the pressure sensor with the plane configuration was 800 Hz, and that of the pressure sensor in accordance with the first embodiment was 1,850 Hz. Therefore the pressure sensor configured with the bent fixing plate in accordance with the present embodiment proves to be strong against low frequency vibration. On the other hand, the sensitivity of the pressure-sensitive element of the pressure sensor with the plane configuration was 2 Hz/atm, but there is a tendency that the sensitivity of the pressure-sensitive element of the pressure sensor in accordance with the present embodiment lowers, and it was 1.4 Hz/atm.

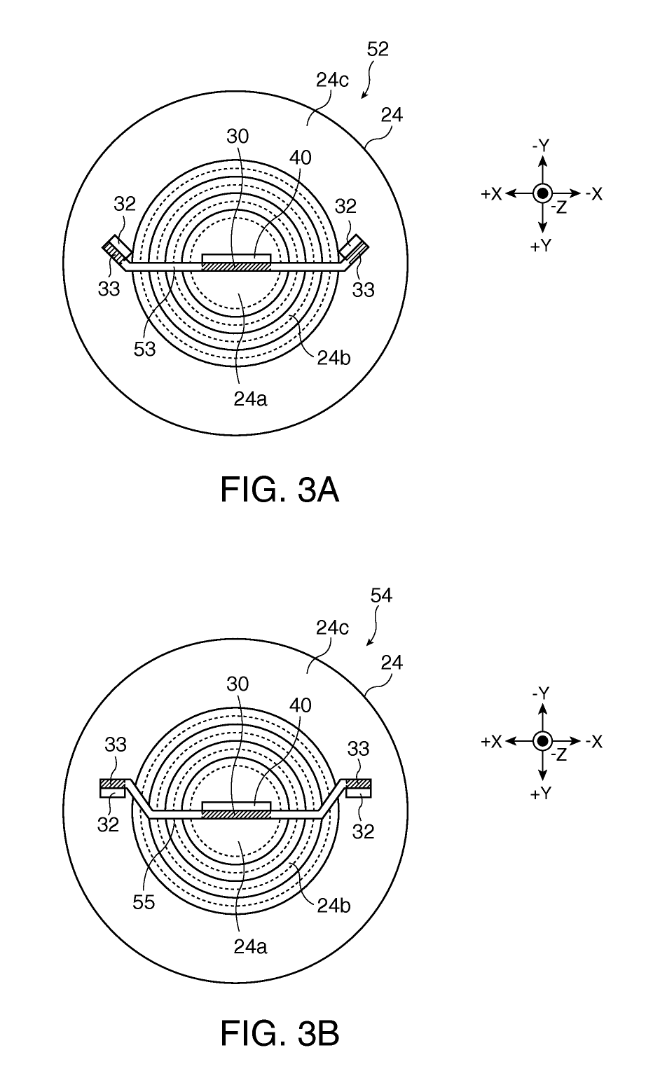

FIGS. 3A and 3B are diagrammatic views of pressure sensors 52 and 54 in accordance with modified examples 1 and 2 of the first embodiment, where FIG. 3A is a cross-sectional view of the modified example 1 (excluding the housing) taken along XY plane, and FIG. 3B is a cross-sectional view of the modified example 2 (excluding the housing) taken along XY plane. The pressure sensor 52 in accordance with the modified example 1 shown in FIG. 3A includes a fixing plate 53 having a first connection segment. Both end sections of the first connection segment are bent at blunt angles as viewed in a plan view as they are extended toward one of the main surface sides. The pressure sensor 54 in accordance with the second modified example 2 shown in FIG. 3B includes a fixing plate 55 having a first connection segment. Both end sections of the first connection segment are bent at blunt angles as viewed in a plan view, and then bent further to be in parallel with the first connection section as they are extended toward one of the main surface sides. The fixing plates 52 and 55 in accordance with the modified examples 1 and 2 may be formed by welding. The pressure sensors 52 and 54 in accordance with the modified examples 1 and 2 can achieve effects similar to those of the pressure sensor 10 in accordance with the first embodiment.

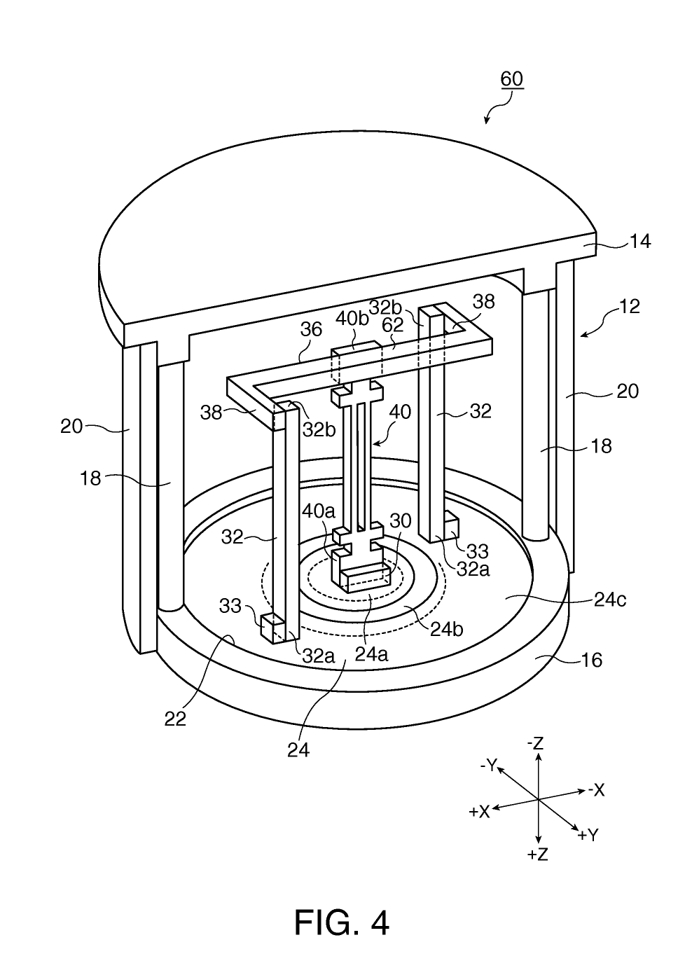

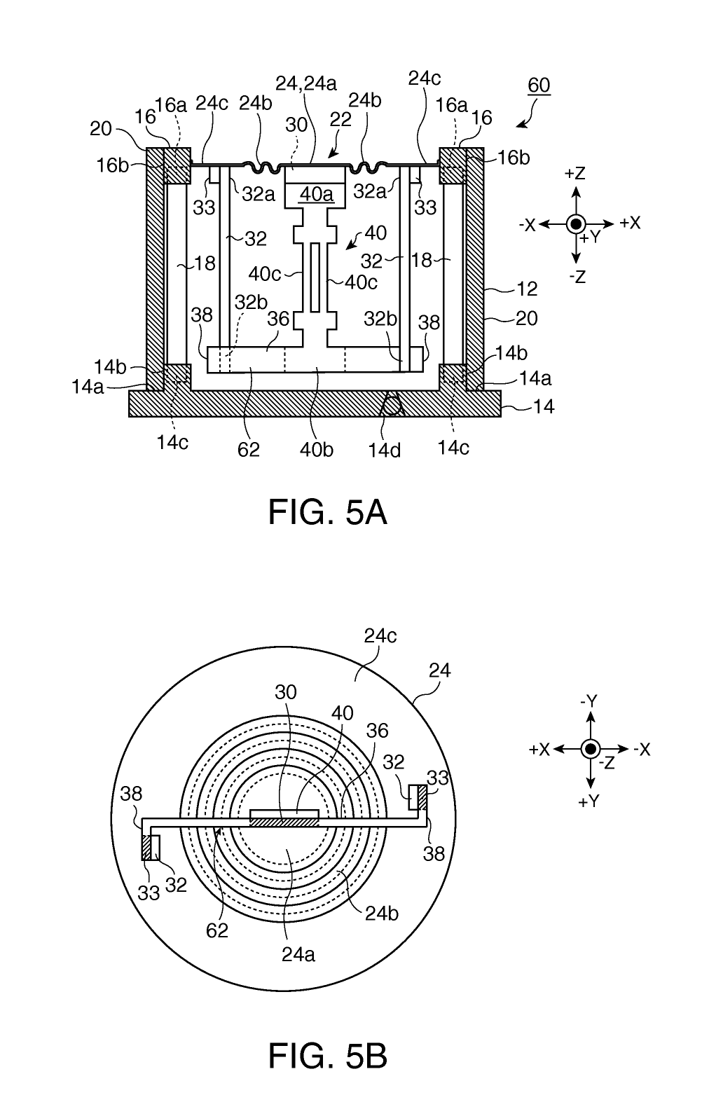

FIG. 4 is a perspective view of a pressure sensor 60 in accordance with a second embodiment with a portion thereof being exposed. FIGS. 5A and 5B are cross-sectional views of the pressure sensor 60 in accordance with the second embodiment, where FIG. 5A is a cross-sectional view taken along XZ plane, and FIG. 5B is a cross-sectional view (excluding the housing) taken along XY plane.

The pressure sensor 60 in accordance with the second embodiment generally has the same base configuration as that of the pressure sensor 10 in accordance with the first embodiment, but the configuration of its fixing plate 62 and connecting locations of its support members 32 are different. As the other constituting elements are the same as those of the first embodiment, they will be appended with the same reference numbers, and their detailed description will be omitted.

The fixing plate 62 of the pressure sensor 60 in accordance with the second embodiment generally has the same base configuration as that of the fixing plate 34 of the first embodiment. The fixing plate 62 in accordance with the second embodiment has a first connection segment 36 that is bonded to the second base portion 40b of the pressure-sensitive element 40. Two end sections of the first connection segment 36 are bent at right angle (to be extended) toward one of the main planes and the other of the main planes with respect to a first bonding surface, to define second bonding surfaces, respectively, whereby the overall configuration of the fixing plate 62 is formed into a crank shape, or a generally S letter shape, as viewed in a plan view. It is noted that the second connection segments 38 are formed to be positioned in areas that are superposed with the peripheral edge area 24c of the diaphragm 24 as viewed in a plan view, when the first connection segment 36 is connected to the second base portion 40b of the pressure-sensitive element 40. The fixing plate 62 may be formed by bending a flat plate into a crank shape or a generally S letter shape to define the first and second connection segments 36 and 38, or may be formed by, for example, welding a pair of connection segments defining the second connection segments 38 to a connection segment defining the first connection segment 36.

The support members 32 are affixed to the diaphragm 24 with one ends 32a thereof disposed in a manner to traverse the peripheral edge area 24c of the diaphragm 24. The other ends 32b of the support members 32 are arranged to extend from the one ends 32a in parallel with a displacement direction (the Z axis direction) of the pressure-sensitive element 40, and are affixed to the second connection segments 38 of the fixing plate 62. The one ends 32a of the support members 32 are bonded and affixed to the second support bases 33 that stand from the peripheral edge area 24c of the diaphragm 24.

The pressure sensor 60 in accordance with the second embodiment is also configured such that two ends of a first bonding surface of the fixing plate 64 are extended toward one and the other of the main surface sides with respect to the first bonding surface, thereby forming second bonding surfaces, such that the first and second bonding surfaces of the fixing plate 62 are not on the same plane, in other words, the bonding surface of the second base portion 40b of the pressure-sensitive element 40 and the bonding surfaces of the other ends of the support members are not on the same plane. By this configuration, the second base portion 40b of the pressure-sensitive element 40 is supported by the fixing plate 62 and the supporting members 32 from one and the other of the main surface sides. Therefore, the fixing plate 62 and the supporting members 32 can act as stoppers to counter external force such as vibrations and impacts in a direction perpendicular to the element plane of the pressure-sensitive element 40. Accordingly, the impact tolerance against external force to the element plane of the pressure-sensitive element 40 can be improved.

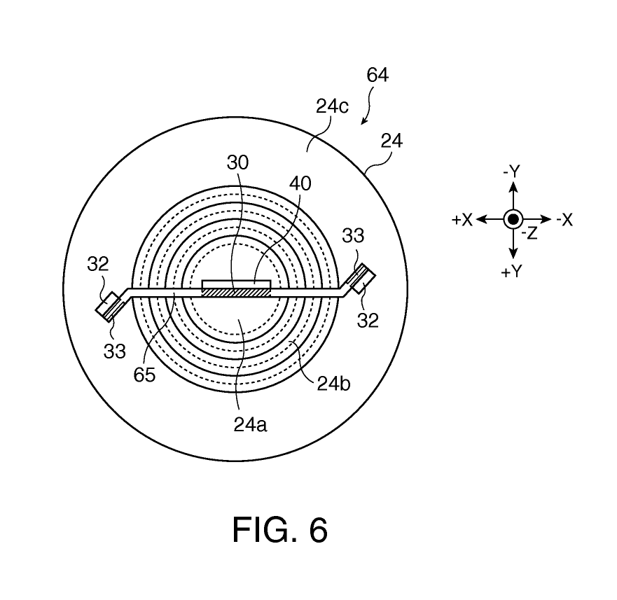

FIG. 6 is a cross-sectional view of a pressure sensor 64 in accordance with a modified example 3 (excluding the housing) of the second embodiment taken along XY plane. The pressure sensor 64 in accordance with the modified example 3 shown in FIG. 6 includes a fixing plate 65 having a first connection segment. Two end sections of the first connection segment are bent at blunt angles as viewed in a plan view when they are extended toward one and the other of the main surface sides, respectively. The fixing plate 65 in accordance with the modified example 3 may be formed by welding. The pressure sensor 64 in accordance with the modified example 3 can also exhibit effects similar to those of the pressure sensor 60 in accordance with the second embodiment.

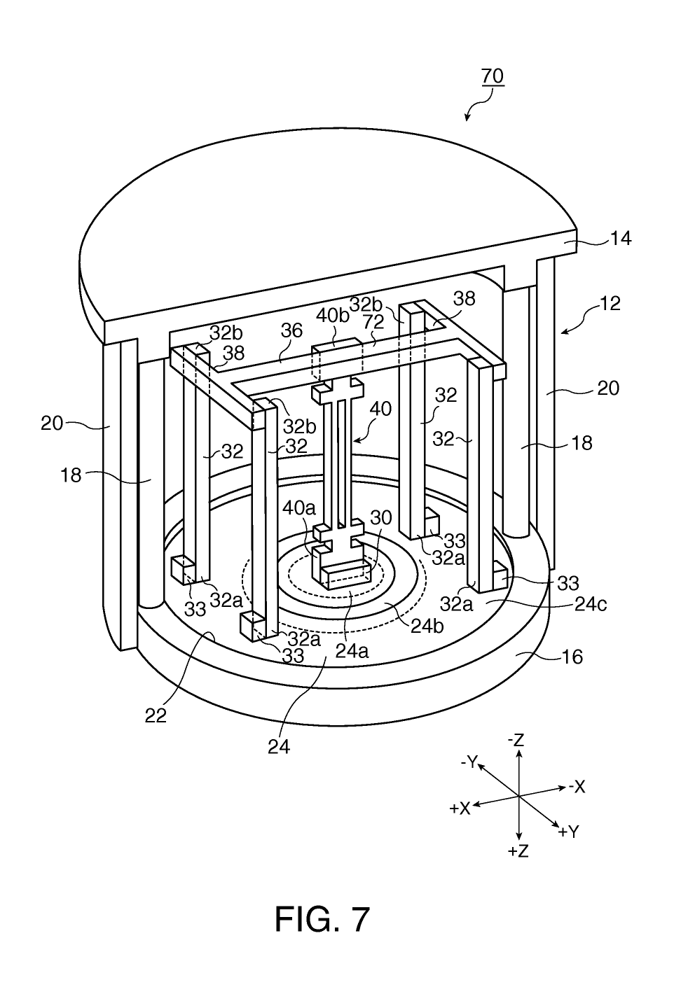

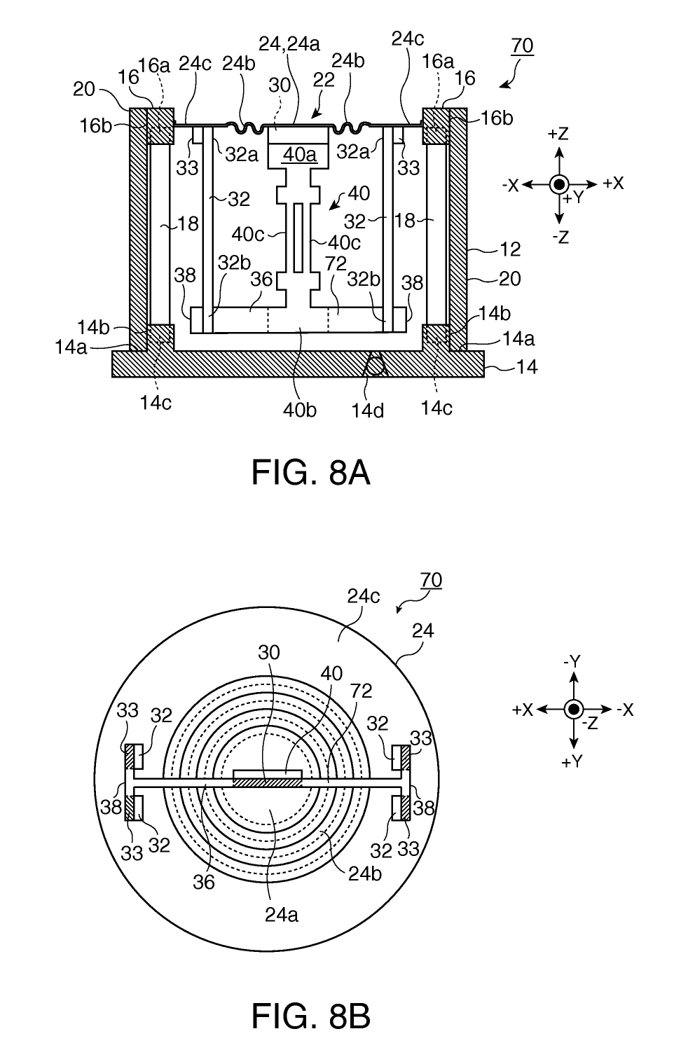

FIG. 7 is a perspective view of a pressure sensor 70 in accordance with a third embodiment with a portion thereof being exposed. FIGS. 8A and 8B are cross-sectional views of the pressure sensor 70 in accordance with the third embodiment, where FIG. 8A is a cross-sectional view (excluding the housing) taken along XZ plane, and FIG. 8B is a cross-sectional view taken along XY plane.

The pressure sensor 70 in accordance with the third embodiment generally has the same base configuration as that of the pressure sensor 10 in accordance with the first embodiment, but the configuration of its fixing plate 72 and connecting locations of its support members 32 are different. As the other constituting elements are the same as those of the first embodiment, they will be appended with the same reference numbers, and their detailed description will be omitted.

The fixing plate 72 of the pressure sensor 70 in accordance with the third embodiment generally has the same base configuration as that of the fixing plate 34 of the first embodiment. The fixing plate 72 in accordance with the third embodiment has a first connection segment 36 that is bonded to the second base portion 40b of the pressure-sensitive element 40. Two end sections of the first connection segment 36 are bent at right angle (to be extended) toward both of the main planes (one and the other of the main planes) with respect to a first bonding surface, to define second bonding surfaces, respectively, whereby the overall configuration of the fixing plate 72 is formed into a generally H letter shape, as viewed in a plan view. It is noted that the second connection segments 38 are formed to be positioned in areas that are superposed with the peripheral edge area 24c of the diaphragm 24 as viewed in a plan view, when the first connection segment 36 is connected to the second base portion 40b of the pressure-sensitive element 40. The fixing plate 72 may be formed by welding a pair of connection segments defining the second connection segments 38 to both ends of a connection segment defining the first connection segment 36.

The support members 32 are affixed to the diaphragm 24 with one ends 32a thereof disposed in a manner to traverse the peripheral edge area 24c of the diaphragm 24. The other ends 32b of the support members 32 are arranged to extend at four locations from the one ends 32a in parallel with a displacement direction (the Z axis direction) of the pressure-sensitive element 40, and are affixed to the second connection segments 38 of the fixing plate 72. The one ends 32a of the support members 32 are bonded and affixed to the second support bases 33 that stand from the peripheral edge area 24c of the diaphragm 24.

The pressure sensor 70 in accordance with the third embodiment is also configured such that two ends of a first bonding surface of the fixing plate 72 are extended toward one and the other of the main surface sides with respect to the first bonding surface, thereby forming second bonding surfaces, such that the first and second bonding surfaces of the fixing plate 72 are not on the same plane, in other words, the bonding surface of the second base portion 40b of the pressure-sensitive element 40 and the bonding surfaces of the other ends of the support members 32 are not on the same plane. By this configuration, the second base portion 40b of the pressure-sensitive element 40 is supported by the fixing plate 72 and the supporting members 32 from one and the other of the main surface sides. Therefore, the fixing plate 72 and the supporting members 32 can act as stoppers to counter external force such as vibrations and impacts in a direction perpendicular to the element plane of the pressure-sensitive element 40. Accordingly, the impact tolerance against external force to the element plane of the pressure-sensitive element 40 can be improved.

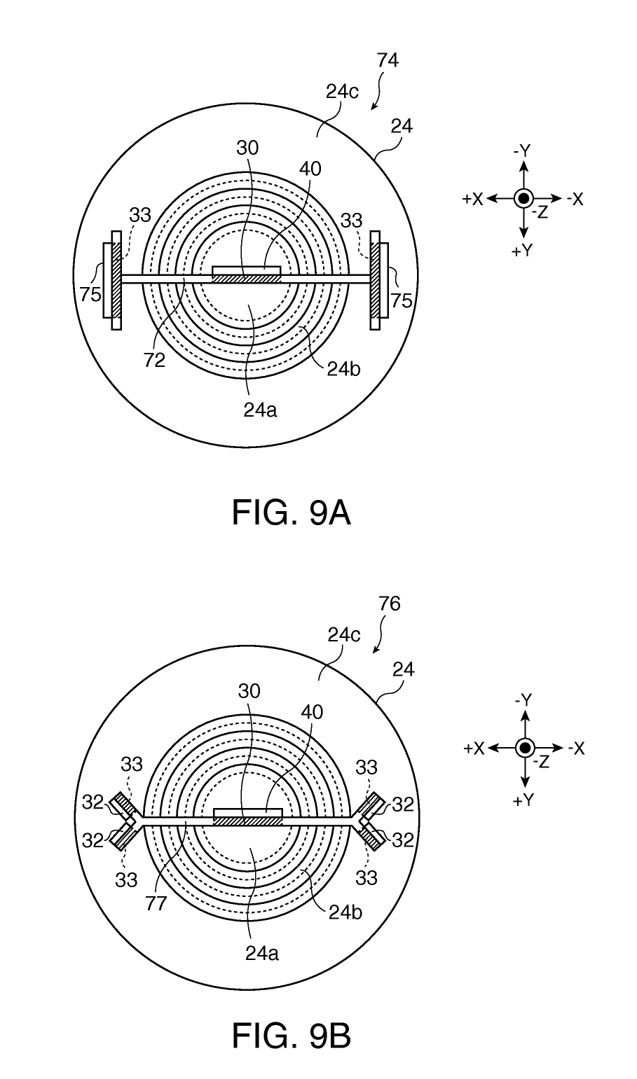

FIGS. 9A and 9B are diagrammatic views of pressure sensors 74 and 76 in accordance with modified examples 4 and 5 of the third embodiment, where FIG. 9A is a cross-sectional view of the modified example 4 (excluding the housing) taken along XY plane, and FIG. 9B is a cross-sectional view of the modified example 5 (excluding the housing) taken along XY plane.

The pressure sensor 74 in accordance with the modified example 4 shown in FIG. 9A uses the fixing plate 72 in accordance with the third embodiment, and one supporting member 75 is bonded to each of the second connection segments. In this case, the support member 75 is set to have a greater width than those of the support members 32 in accordance with the first-third embodiments, and is bonded at a location where the first bonding surface and the second bonding surface intersect each other. The pressure sensor 76 in accordance with the modified example 5 shown in FIG. 9B has a fixing plate 77 having a first connection segment. Both of the end sections of the first connection segment are extended at blunt angles, as they are extended to one and the other of the main surface sides, respectively, thereby forming a generally Y letter shape at each end, as viewed in a plan view. The pressure sensors 74 and 76 in accordance with the modified examples 4 and 5 can also achieve effects similar to those of the pressure sensor 70 in accordance with the third embodiment.

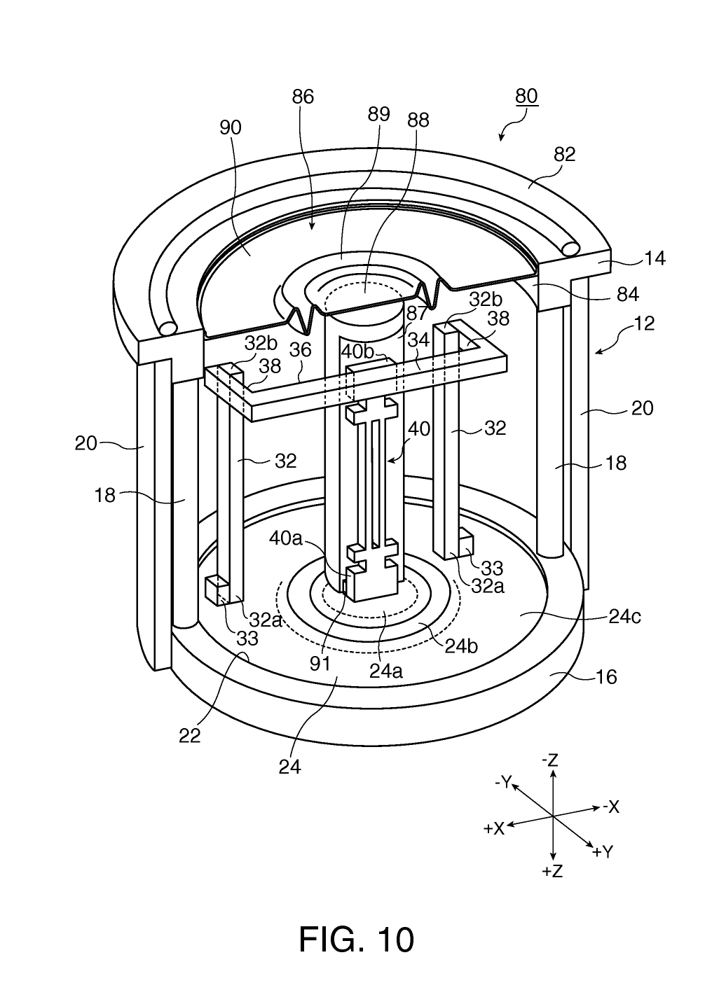

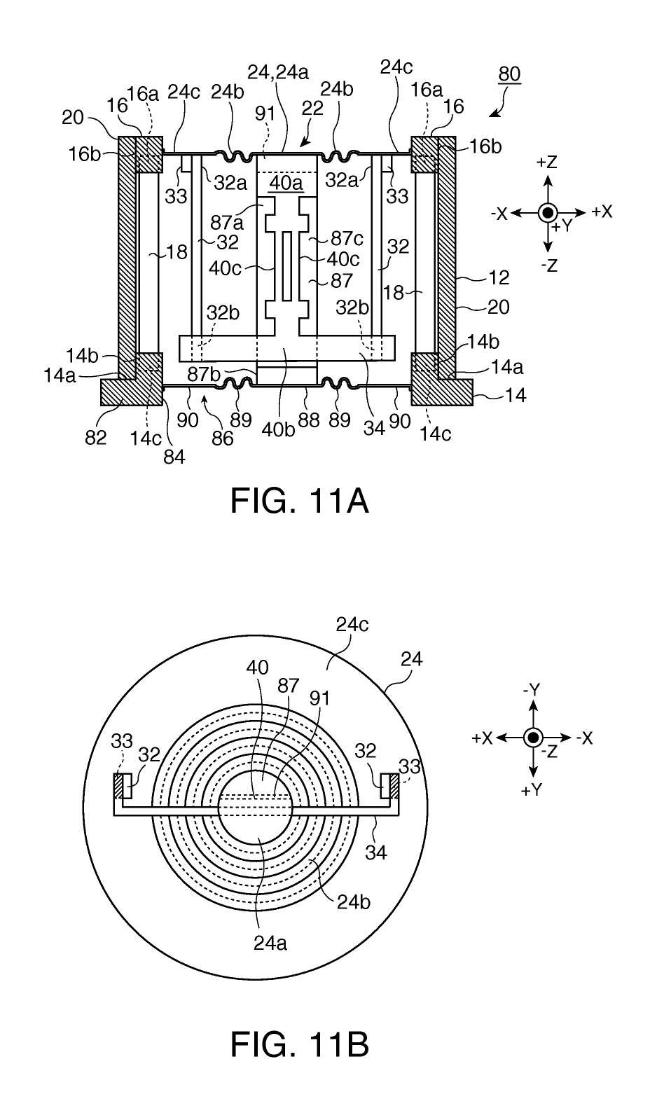

FIG. 10 is a perspective view of a pressure sensor 80 in accordance with a fourth embodiment with a portion thereof being exposed. FIGS. 11A and 11B are cross-sectional views of the pressure sensor 80 in accordance with the fourth embodiment, where FIG. 11A is a cross-sectional view taken along XZ plane, and FIG. 11B is a cross-sectional view (excluding the housing) taken along XY plane.

The pressure sensor 80 in accordance with the fourth embodiment includes a first diaphragm 24 that serves as a pressure receiving unit provided at an opening of the ring portion 16 composing the housing. The pressure sensor 80 includes a flange portion 82 that has a second opening 84 formed opposite to the opening 22 of the ring portion 16, and the second opening 84 is sealed by a second diaphragm 86 that serves as a second pressure receiving unit. The first diaphragm 24 and the second diaphragm 86 are connected to each other through a force transmission shaft 87. The first and second diaphragms 24 and 86 include, respectively, center areas 24a and 88 which can be displaced by pressure from the outside, flexible areas 24b and 89 located on the outer periphery of the center areas and subjected to the flexural deformation by pressure from the outside, and peripheral edge areas 24c and 90 located on the outer periphery of the flexible areas 24b and 89 and joined to the ring portion 16 and to the opening 84 of the flange portion 82, respectively.

The force transmission shaft 87 is disposed inside the housing 12. One end 87a of the force transmission shaft 87 in the longitudinal direction is connected to the center area 24a of the first diaphragm 24, and the other end 130b thereof on the opposite side of the one end 87a is connected to the center area 88 of the second diaphragm 86. The force transmission shaft 87 has a cylindrical columnar shape, and has a counter boring 87c formed to avoid interference with the pressure-sensitive element 40 and the fixing plate 34. Therefore, the force transmission shaft 87 has a semicircular cross section on the side of the first diaphragm 24, and a circular cross section on the side of the second diaphragm 86. For affixing the first base portion 40a of the pressure-sensitive element 40 to the first diaphragm 24, a connection segment of the first base portion 40a is connected to the counter boring 87c through a spacer 91, and a tip of the first base portion 40a is abutted to the center area 24a. The force transmission shaft 87 is preferably made of the same material as that of the support shafts 18. Accordingly, no difference is generated in the amount of expansion and contraction between the force transmission shaft 87 and the support shafts 18 in the detection axis direction of the pressure-sensitive element 40 caused by temperature changes, which derives from a difference in the thermal expansion coefficient between the force transmission shaft 87 and the support shafts 18, and therefore the force exerted from the force transmission shaft 87 to the first and second diaphragms 24 and 86 is maintained at constant regardless of temperature changes, such that the sensitivity of the pressure sensor 80 can be prevented from varying depending on temperature changes.

With such a structure, when the pressure on the side of the first diaphragm 24 is higher, the force transmission shaft 87 acts to push the center portion 88 of the second diaphragm 86 toward the outside of the housing 12, and the pressure-sensitive element 40 is subjected to compressive stress. On the other hand, when the pressure on the side of the second diaphragm 86 is higher, the force transmission shaft 87 acts to push the center area 24a of the first diaphragm 24 toward the outside of the housing 12 and the pressure-sensitive element 40 is subjected to extensional stress. Accordingly, by application of the third embodiment, the pressure sensors 10, 60 and 70 according to the first-third embodiments can be formed as pressure sensors which can measure relative pressure.

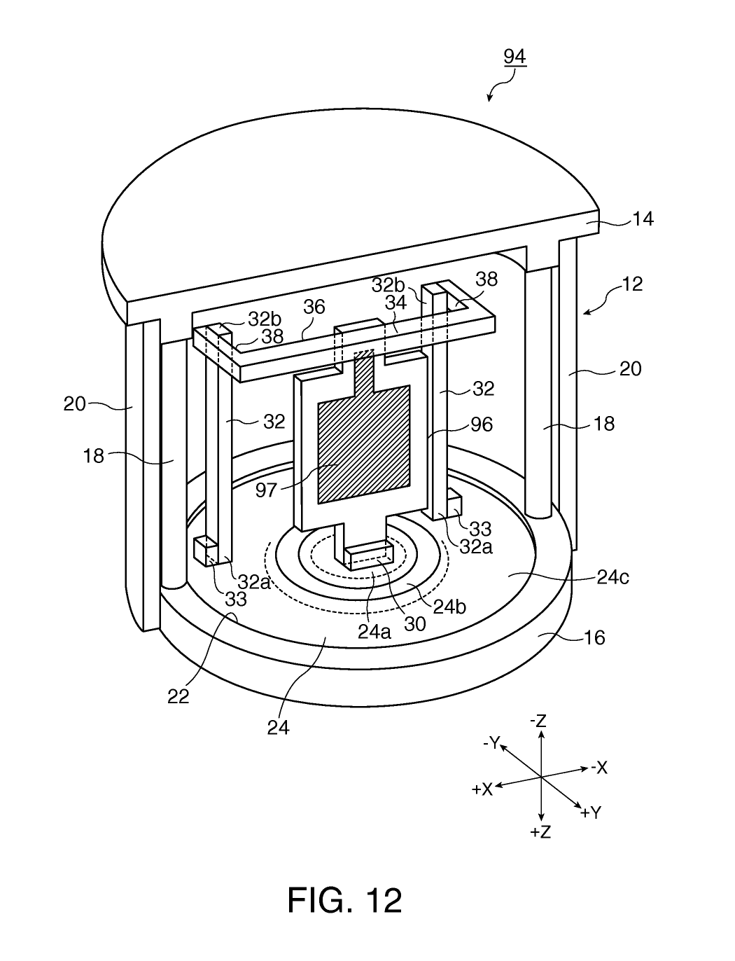

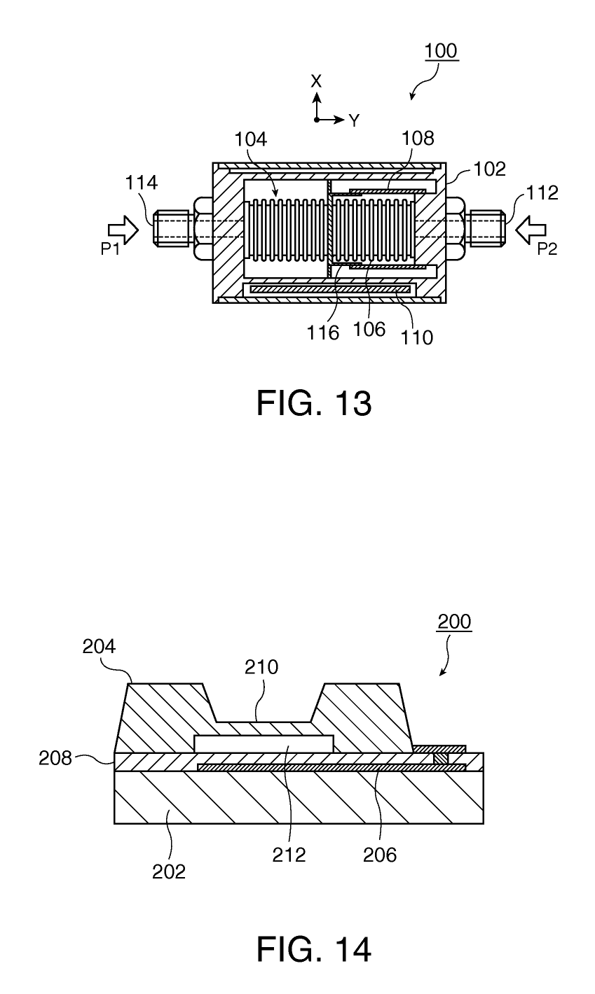

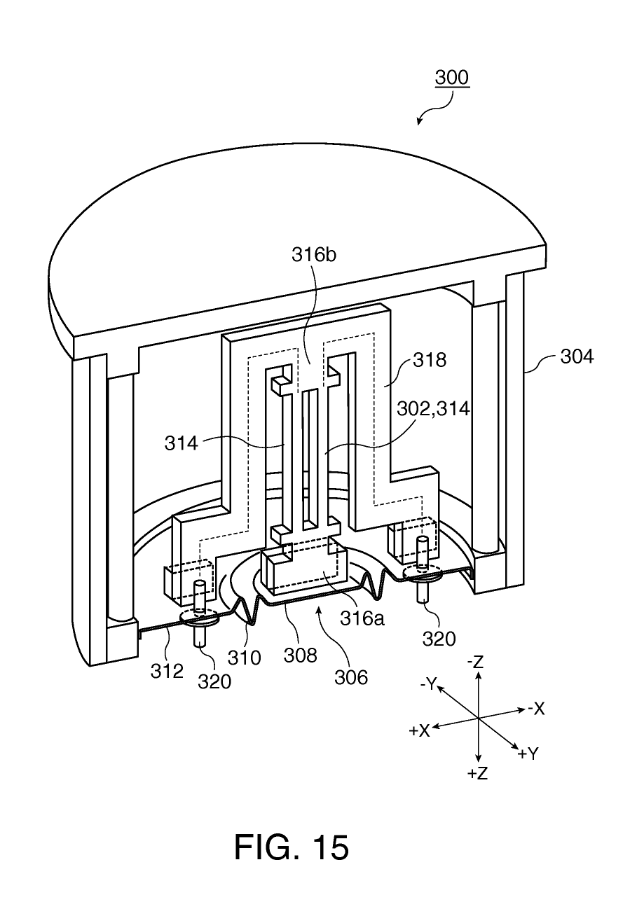

FIG. 12 is a perspective view of a pressure sensor 94 in accordance with a fifth embodiment with a portion thereof being exposed. The pressure sensor 94 uses an AT-cut crystal quartz oscillator as a pressure-sensitive element 96. The fifth embodiment will be described with reference to a configuration in which the present embodiment is applied to the first embodiment. However, it is noted that the present embodiment is also applicable to the second-fourth embodiments. The AT-cut crystal quartz oscillator is comprised of a so-called AT-cut crystal quartz chip obtained by cutting a crystal quartz substrate in parallel with the X-axis but at an angle adjacent to 35.15 degrees with respect to the Z-axis. A pair of excitation electrodes 97 is provided on both main surfaces of the AT-cut crystal quartz chip. As AT-cut crystal quartz oscillators generally have a higher frequency than tuning-fork type crystal quartz oscillators, their measurement speed is high and therefore high-speed measurement becomes possible. Accordingly, the fifth embodiment may be applicable to pressure sensors that require quick pressure measurement, such as, tire pressure sensors or the like.

The entire disclosure of Japanese Patent Application No. 2010-238948, filed Oct. 25, 2010 is expressly incorporated by reference herein.

1. A pressure sensor comprising:
a container;
a pressure receiving unit that seals an opening section of the container, has a pressure receiving section and a peripheral section outside the pressure receiving section, and displaces inwardly or outwardly of the container upon receiving a force;
a plurality of support members having one ends affixed to the peripheral section and other ends that extend from the one ends in parallel with a direction of displacement of the pressure receiving unit;
a pressure-sensitive element having a first base portion affixed to the pressure receiving section and a second base portion disposed extending from the first base portion in parallel with the direction of displacement of the pressure receiving unit; and
a fixing plate having a first connection segment that affixes the second base portion of the pressure-sensitive element, and a second connection segment that extends both ends of the first connection segment toward at least one of main surface sides of the first connection segment thereby and connect to the other ends of the support members.

2. A pressure sensor according to claim 1, wherein the second connection segment extends one of the ends of the first connection segment toward the one of the main surface sides of the first connection segment, and extends the other of the ends of the first connection segment toward the other of the main surface sides of the first connection segment thereby connecting to the other ends of the support members.

3. A pressure sensor according to claim 1, wherein the second connection segment extends both ends of the first connection segment toward both of the main surface sides of the first connection segment thereby connecting to the other ends of the support members.

4. A pressure sensor according to claim 1, wherein the container includes a second opening section formed opposite to the opening section, the second opening section is sealed by a second pressure receiving unit, and the pressure receiving unit and the second pressure receiving unit are connected to each other through a force transmission shaft.

5. The pressure sensor according to claim 1,
wherein the pressure sensing portion includes at least one columnar beam.

6. The pressure sensor according to claim 4,
wherein the pressure sensing portion includes at least one columnar beam.

7. A pressure sensor according to claim 1,
wherein the pressure-sensitive element is an AT-cut quartz crystal unit.

8. A pressure sensor according to claim 4,
wherein the pressure-sensitive element is an AT-cut quartz crystal unit.

9. The pressure sensor according to claim 2,
wherein the pressure sensing portion includes at least one columnar beam.

10. The pressure sensor according to claim 3,
wherein the pressure sensing portion includes at least one columnar beam.

11. A pressure sensor according to claim 2,
wherein the pressure-sensitive element is an AT-cut quartz crystal unit.

12. A pressure sensor according to claim 3,
wherein the pressure-sensitive element is an AT-cut quartz crystal unit.
